(19) United States
(12) Patent Application Publication
(10) Pub. No.: US 2013/0110799 A1
(43) Pub. Date: May 2, 2013

(54) ACCESS TO HETEROGENEOUS DATA SOURCES

(71) Applicants: Sally Blue Hoppe, Corvallis, OR (US); William Hernandez, Saint Johns, FL (US)

(72) Inventors: Sally Blue Hoppe, Corvallis, OR (US); William Hernandez, Saint Johns, FL (US)

(21) Appl. No.: 13/285,888

(22) Filed: Oct. 31, 2011

(51) Int. Cl. G06F 17/30

(52) U.S. Cl. 707/705; 707/E17.044; 707/E17.032

(57) ABSTRACT

In one implementation, an apparatus includes a plurality of data access object (DAO) interfaces to facilitate interactions with a plurality of heterogeneous data sources, in which each of the plurality of DAO interfaces is to facilitate interaction with a different type of data source. The apparatus also includes a controller to receive an interaction request, to determine a data source of the plurality of data sources that is to service the interaction request, to select the DAO interface associated with the determined data source, and to implement the selected DAO interface to delegate communication of the interaction request for servicing of the interaction request by the determined data source.

### BACKGROUND

Data is often collected and stored into databases that operate under a number of different types of file formats. The different types of databases include, for instance, a flat file database, a relational database, and an object database. In each of these types of databases, data is stored in formats that are specific to each of the different types of databases. As such, access to the data stored in the different types of databases requires different types of mechanisms, for instance, different application program interfaces (APIs). The different types of mechanisms are typically incompatible with each other and thus access to each of the different databases is commonly provided through different interfaces, one for each type of database.

### BRIEF DESCRIPTION OF THE DRAWINGS

Features of the present disclosure are illustrated by way of example and not limited in the following figure(s), in which like numerals may indicate like elements, in which:

FIG. 1 shows a simplified block diagram of a directory services environment in which various aspects of the methods disclosed herein may be implemented, according to an example of the present disclosure;

FIG. 2 depicts a more detailed block diagram of the directory services apparatus depicted in FIG. 1, according to an example of the present disclosure;

FIG. 3 depicts a flow diagram of a method for managing access to a plurality of heterogeneous data sources, according to an example of the present disclosure; and

FIG. 4 illustrates a schematic representation of a computing device, which may be employed to perform various functions of the directory services apparatus depicted in FIGS. 1 and 2, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on.

Disclosed herein are an apparatus and method for managing access to a plurality of heterogeneous data sources through utilization of data access object (hereinafter “DAO”) interfaces. Each of the DAO interfaces is to facilitate interaction with a different type of data source. In other words, each of the DAO interfaces is to map interaction requests to a respective DAO associated with a particular one of the heterogeneous data sources and to forward the interaction request to mapped DAO.

Generally speaking, a controller is to receive an interaction request through an interface, such as, a web-based interface. The interaction request may include, for instance, a request to retrieve, modify, delete, sort, etc., data stored in any one of the heterogeneous data sources. The controller is to determine which of the heterogeneous data sources contains the data associated with the interaction request from information contained in a configuration file. As such, users that submit the interaction requests need not know the actual locations and file formats of the data contained in the heterogeneous data sources. Moreover, the users may access the data contained in the heterogeneous data sources through a common interface.

According to an example, the configuration file is to be updated as changes are made to the backend storage of the data in the data sources. In this regard, when changes are made to the storage of the data in the data sources, such as, changes to the format in which the data is stored in a data source, the configuration file may be modified to reflect those changes. In addition, the DAO interfaces may remain the same following the changes to the format in which the data is stored in the data sources, however, the mapping of the DAO interfaces to particular ones of the DAOs may be changed. In other words, the DAOs that are associated with the data sources may remain the same, but the DAO interfaces may be mapped to different ones of the DAOs following changes to the format in which the data is stored in the data sources.

Through implementation of the apparatus and method disclosed herein, directory services, such as, interactions with directory data stored on heterogeneous data sources may be provided through a single interface. Moreover, the apparatus and method disclosed herein enable a variety of different types of data sources to be accessed without requiring that source code of components that depend on the directory information be changed. Instead, the configuration information may be modified and this modification may be sufficient for servicing interaction requests in the heterogeneous data sources.

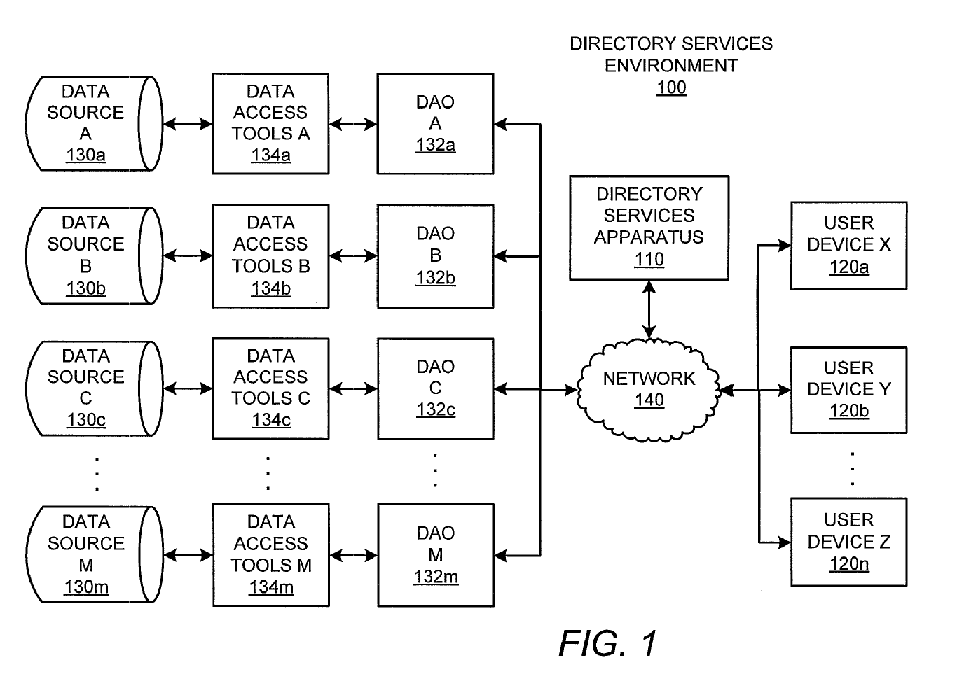

With reference first to FIG. 1, there is shown a simplified block diagram of a directory services environment 100 in which various aspects of the methods disclosed herein may be implemented, according to an example of the present disclosure. It should be understood that the directory services environment 100 depicted in FIG. 1 may include additional elements and that some of the elements described herein may be removed and/or modified without departing from a scope of the directory services environment 100.

The directory services environment 100 is depicted as including a directory services apparatus 110, a plurality of user devices 120a-120n, a plurality of data sources 130a-130m, and a network 140. The variables “n” and “m” generally denote integer values greater than one. In any regard, the directory services apparatus 110 is depicted as being in communication with the user devices 120a-120n and the data sources 130a-130m through the network 140. The network 140 may comprise any suitable network for facilitating communication of data between the elements of the directory services environment 100. Examples of suitable networks 140 include the Internet, a cellular network, a local area network, a wide area network, etc.

The data sources 130a-130m comprise repositories, databases, etc., that store data that is accessible through directory services. In addition, the data sources 130a-130m comprise heterogeneous types of data sources. More particularly, for instance, at least one of the data sources A 130a may comprise a Lightweight Directory Access Protocol (LDAP) database and at least another one of the data sources B 130b may comprise a relational database. In addition, at least a further one of the data sources C 130c may comprise an Extensible Markup Language (XML) database and at least a further one of the data sources M 130m may comprise an Enterprise Active Directory database. The heterogeneous data sources 130a-130m may also comprise other types of data sources so long as at least two of the data sources are heterogeneous with respect to each other.

As also shown in FIG. 1, each of the heterogeneous data sources 130a-130m is associated with respective data access objects (DAOs) 132a-132m and respective data access tools 134a-134m. The DAOs 132a-132m and the data access tools 134a-134m generally enable various interactions or transactions to be performed with respect to the heterogeneous data sources 130a-130m. In this regard, each of the DAOs 132a-132m and the access tools 134a-134m may be particularly suited for a respective one of the heterogeneous data sources 130a-130m. The DAOs 132a-132m and the access tools 134a-134m are discussed in greater detail herein below.

The user devices 120a-120n generally comprise any suitable electronic device through which users may interact with the data sources 130a-130m. For instance, the user devices 120a-120n may comprise, personal computers, laptop computers, tablet PCs, smartphones, e-book readers, personal digital assistants, portable media players, etc. In addition, the user devices 120a-120n may connect to the network 140 through any suitable connection, such as, through a wifi connection, a cellular connection, a wifi hotspot, a local area network connection that is connected to the network 140, etc.

Users may input interaction requests through the user devices 120a-120n for servicing by the directory services apparatus 110. The input interaction requests may comprise, for instance, requests for retrieval of particular data, requests to store data, requests to modify data, requests to delete data, etc. According to an example, an interface, such as a web-based interface, may be presented on the user devices 120a-120n through which users may input the interaction requests. As discussed below, because the directory services apparatus 110 performs various backend processes for the interaction requests to be serviced, the directory services apparatus 110 enables the interaction requests to be received in a common format through a single interface. As such, users may input the interaction requests through the single interface regardless of the heterogeneous data source 130a-130m in which the data corresponding to the interaction requests is stored.

The directory services apparatus 110 comprises a server or other computing device and is generally to manage access to the data stored in the heterogeneous data sources 130a-130m. More particularly, the directory services apparatus 110 is to receive interaction requests from the user devices 120a-120n through the network 140. In addition, the directory services apparatus 110 comprises various components that are to determine which of the data sources 130a-130m is to service the interaction requests. Moreover, the various components are to communicate the interaction requests to the appropriate data source 130a-130m for servicing of the interaction requests.

In communicating the interaction requests, the directory services apparatus 110 is to communicate the interaction requests to the appropriate DAOs 132a-132m corresponding to the data sources 130a-130m that are to service the interaction requests. The DAOs 132a-132m convert the interaction requests into commands suitable for implementation on respective ones of the data sources 130a-130m. In addition, the data access tools 134a-134m implement the converted interaction requests on the respective data sources 130a-130m. By way of example in which the data source 130a comprises an LDAP database, the DAO 132a comprises an LDAP DAO 132a and the data access tools 134a may comprise a Spring LDAP and a Java Naming Directory Interface (JNDI) tool. As another example in which the data source 130b comprises a relational database, the DAO 132b comprises a Relational Database Management System (RDMS) and the data access tools 134b may comprise a Hibernate tool and a Java Database Connectivity (JDBC) driver. As a further example in which the data source 130c comprises an XML database, the DAO 132c comprises an XML DAO and the data access tools 134c may comprise a Java Architecture for XML Binding (JAXB) tool. As a still further example in which the data source 130m comprises an Enterprise Active Directory database, the DAO 132m comprises an Active Directory DAO 132m and the data access tools 134m may comprise a Spring LDAP and a Java Naming Directory Interface (JNDI) tool.

According to an example, the data source 130a, DAO 132a, and the data access tools 134a may be contained in a server. Likewise, the data source 130b, DAO 132b, and the data access tools 134b may be contained in a server. In addition, or alternatively, the at least one of the DAOs 132a-132m may be stored in a computing device that is separate from a computing device containing the respective data access tools 134a-134m and the heterogeneous data sources 130a-130m.

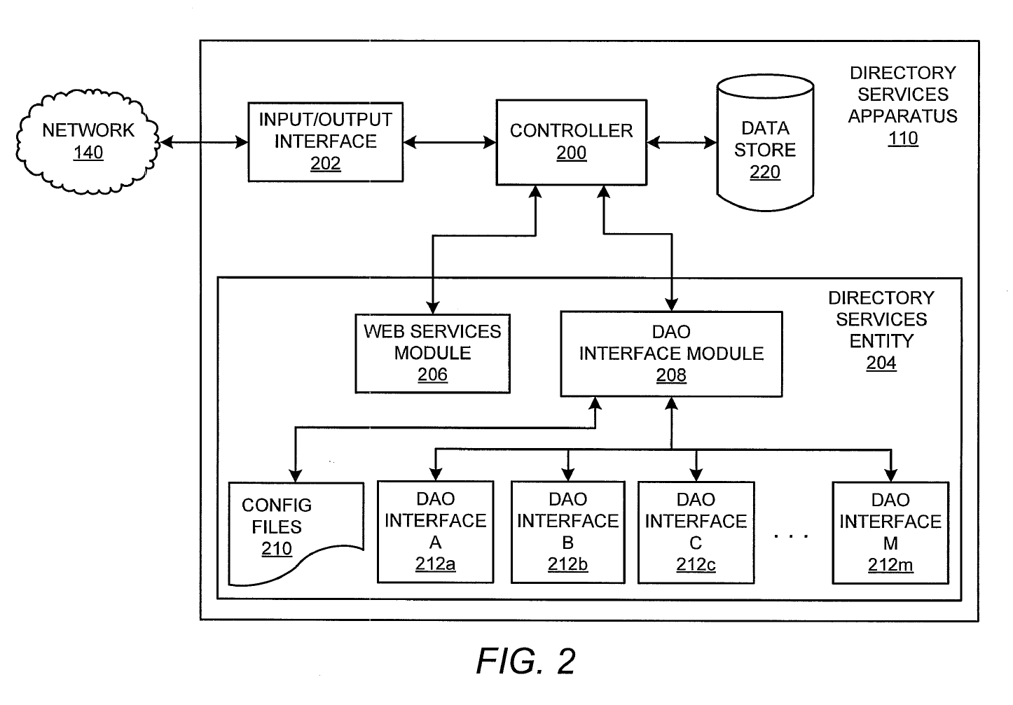

Turning now to FIG. 2, there is shown a more detailed block diagram of the directory services apparatus 110 depicted in FIG. 1, according to an example. It should be understood that the directory services apparatus 110 may include additional elements and that some of the elements depicted therein may be removed and/or modified without departing from a scope of the directory services apparatus 110.

As shown in FIG. 2, the directory services apparatus 110 includes a controller 200, an input/output interface 202, a directory services entity 204, and a data store 220. The input/output interface 202 generally includes various hardware and/or software components for enabling communications of data to and from the network 140. The directory services entity 204 includes a web services module 206, a DAO interface module 208, configuration files 210, and DAO interfaces 212a-212m.

The controller 200 may comprise a microprocessor, a micro-controller, an application specific integrated circuit (ASIC), and the like. In addition, or alternatively, the controller 200 may comprise a controller layer in the directory services apparatus 110. In any regard, the controller 200 is to perform various processing functions in the directory services apparatus 110. Some of the processing functions include invoking or implementing the modules 206 and 208 contained in the directory services entity 204 as discussed in greater detail herein below.

According to an example, the directory services entity 204 comprises a hardware device, such as, a circuit or multiple circuits arranged on a board. In this example, the modules 206 and 208 comprise circuit components or individual circuits. According to another example, the directory services entity 204 comprises software stored, for instance, in a volatile or non-volatile memory, such as dynamic random access memory (DRAM), electrically erasable programmable read-only memory (EEPROM), magnetoresistive random access memory (MRAM), Memristor, flash memory, floppy disk, a compact disc read only memory (CD-ROM), a digital video disc read only memory (DVD-ROM), or other optical or magnetic media, and the like. In this example, the modules 206 and 208 comprise software modules stored in the memory. According to a further example, the modules 206 and 208 comprise a combination of hardware and software modules.

According to an example, the configuration files 210 and the DAO interfaces 212a-212m may be stored in the data store 220. In another example, the directory services entity 204 and the data store 220 may comprise the same component. In any regard, the data store 220 may comprise volatile and/or non-volatile memory, such as DRAM, EEPROM, MRAM, phase change RAM (PCRAM), Memristor, flash memory, and the like. In addition, or alternatively, the data store 220 may comprise a device that is to read from and write to a removable media, such as, a floppy disk, a CD-ROM, a DVD-ROM, or other optical or magnetic media.

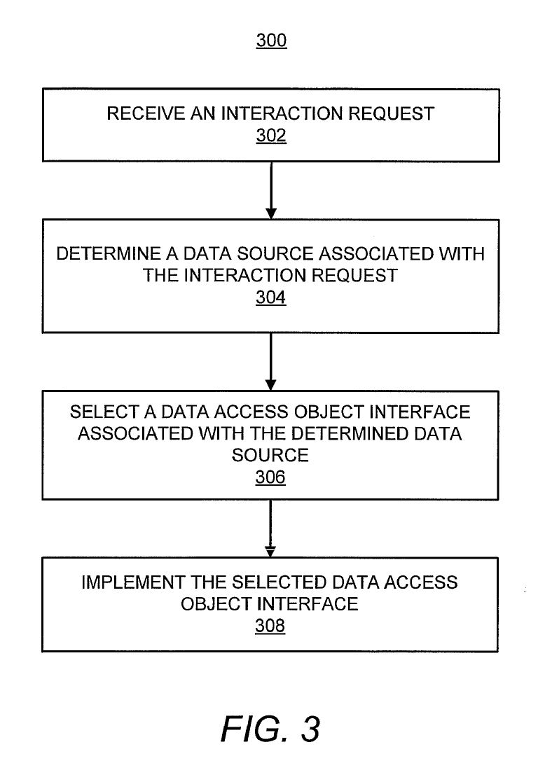

Various manners in which the directory services apparatus 110 may be implemented are discussed in greater detail with respect to the method 300 depicted in FIG. 3. FIG. 3, more particularly, depicts a flow diagram of a method 300 for managing access to a plurality of heterogeneous data sources 130a-130m through utilization of a plurality of DAO interfaces 212a-212m, according to an example. It should be apparent to those of ordinary skill in the art that the method 300 represents a generalized illustration and that other steps may be added or existing steps may be removed, modified or rearranged without departing from a scope of the method 300. Although particular reference is made to the directory services environment 100 and the directory services apparatus 110 depicted in FIGS. 1 and 2 as comprising environments in which the operations described in the method 300 may be performed, it should be understood that the method 300 may be performed in differently configured systems and apparatuses without departing from a scope of the method 300.

At block 302, an interaction request is received into the directory services apparatus 110. The directory services apparatus 110 may receive the interaction request through an interface presented on a user device 120a-120n by the web services module 206. In this example, the interface may comprise a web-based interface through which users may submit interaction requests and from which the interaction requests may be received into the directory services apparatus 110 through the input/output interface 202. Moreover, the interface may be agnostic to the heterogeneous data sources 130a-130m, and may therefore provide access to each of the heterogeneous data sources 130a-130m.

In any regard, the interaction request may comprise a request to interact with data contained in or to be contained in one of the heterogeneous data sources 130a-130m. The interaction requests may include, for instance, a request for retrieval of particular data, a request to store data, a request to modify stored data, a request to delete stored data, etc. In addition, a user may make the interaction request without knowledge of which of the heterogeneous data sources 130a-130m contains the data with which the user would like to interact.

At block 304, the data source 130a-130m that corresponds with the interaction request is determined, for instance, by the DAO interface module 208. More particularly, for instance, the data source 130a-130m that contains the data corresponding to the interaction request and/or the data source 130a-130m to which the data is to be stored is determined at block 304. The DAO interface module 208 is to access the configuration files 210 in making this determination. The configuration files 210 contain at least one of the following information: identities of the data stored in the heterogeneous data sources 130a-130m, the locations of the heterogeneous data sources 130a-130m, the types of the heterogeneous data sources 130a-130m, etc. Thus, for a request for interaction with a particular data, the DAO interface module 208 may use the information contained in the configuration files 210 to determine which of the heterogeneous data sources 130a-130m contains that particular data.

According to an example, the configuration files 210 may be modified and/or updated as changes to the locations in which the data is stored occur. In addition, the configuration files 210 may be modified and/or updated as the types of data sources 130a-130m change. In this regard, updates to the directory services apparatus 110 to operate under modified backend conditions may be made in a relatively easy manner.

At block 306, a DAO interface 212a of the plurality of DAO interfaces 212a-212m that is associated with the data source 130a determined at block 304 is selected, for instance, by a DAO interface module 208. Each of the DAO interfaces 212a-212m may be associated with a particular type of heterogeneous data source 130a-130m. More particularly, each of the DAO interfaces 212a-212m may map to a DAO 132a-132m corresponding to each of the heterogeneous data sources 130a-130m. In addition, each of the DAO interfaces 212a-212m may comprise components that enable communications of data to and from the respective DAOs 132a-132m.

At block 308, the selected DAO interface 212a is implemented to delegate communication of the received interaction request with the determined heterogeneous data source 130a, for instance, by the DAO interface module 208. More particularly, the DAO interface module 208 implements the selected DAD interface 212a to map the interaction request to the DAO 132a associated with the determined data source 130a. In addition, the DAO interface module 208 forwards the interaction request to the mapped DAO 132a. Moreover, as discussed in greater detail herein above, the DAO 132a and the corresponding data access tools 134a cause the interaction request to be serviced by the determined data source 130a.

The method 300 may end following block 308, for instance, if the interaction request was to add data to a particular data source 130a. However, in other instances, the method 300 may also include additional operations. The additional operations may include, for instance, receipt of data from the determined data source 130a and communication of the data to the user device through which the interaction request was received.

According to an example, the directory services apparatus 110 and method 300 may be implemented by a telepresence and/or a visual collaboration studio, such as HALO™, available from Polycom™. In this example, a server or other computing device in the studio may require access to data contained in a particular data source 130a-130m. The data may be required to authenticate the studio, validate an identity of the studio, check a health status of the studio, etc. However, the required data may be stored in any of the heterogeneous data sources 130a-130m. In this example, the servers or other computing devices of the studios may access the required data through implementation of the directory services apparatus 110 and the method 300 without having to know in which of the heterogeneous data sources 130a-130m the required data is stored.

Some or all of the operations set forth in the method 300 may be contained as a utility, program, or subprogram, in any desired computer accessible medium. In addition, the method 300 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include conventional computer system RAM, ROM, EPROM, EEPROM, and magnetic or optical disks or tapes. It is therefore to be understood that any electronic device capable of executing the above-described functions may perform those functions enumerated above.

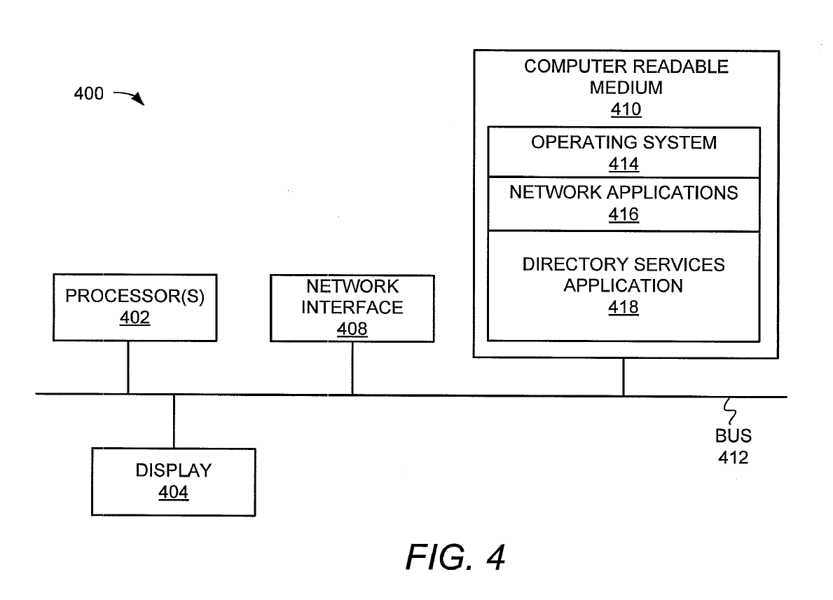

Turning now to FIG. 4, there is shown a schematic representation of a computing device 400, which may be employed to perform various functions of the directory services apparatus 110 depicted in FIGS. 1 and 2, according to an example. The device 400 includes a processor 402, a display 404, such as a monitor; a network interface 408, such as a Local Area Network LAN, a wireless 802.11x LAN, a 3G mobile WAN or a WiMax WAN; and a computer-readable medium 410. Each of these components is operatively coupled to a bus 412. For example, the bus 412 may be an EISA, a PCI, a USB, a FireWire, a NuBus, or a PDS.

The computer readable medium 410 may be any suitable medium that participates in providing instructions to the processor 402 for execution. For example, the computer readable medium 410 may be non-volatile media, such as an optical or a magnetic disk; volatile media, such as memory. The computer-readable medium 410 may also store an operating system 414, such as Mac OS, MS Windows, Unix, or Linux; network applications 416; and a directory services application 418. The operating system 414 may be multi-user, multiprocessing, multitasking, multithreading, real-time and the like. The operating system 414 may also perform basic tasks such as recognizing input from input devices, such as a keyboard or a keypad; sending output to the display 404; keeping track of files and directories on the computer readable medium 510; controlling peripheral devices, such as disk drives, printers, image capture device; and managing traffic on the bus 412. The network applications 416 include various components for establishing and maintaining network connections, such as machine-readable instructions for implementing communication protocols including TCP/IP, HTTP, Ethernet, USB, and FireWire.

The management application 418 provides various components for managing a plurality of data entities to recommend selected ones of the data entities to users, as described above with respect to the method 300 in FIG. 3. The directory services application 418 may thus comprise the directory services entity 204. The directory services application 418 also includes modules to receive an interaction request, to determine a data source of a plurality of heterogeneous data sources that corresponds with the interaction request, to select a DAO interface of the plurality of DAO interfaces associated with the determined heterogeneous data source, and to implement the selected DAO interface to delegate communication of the received interaction request to the determined heterogeneous data source. In certain examples, some or all of the processes performed by the management application 418 may be integrated into the operating system 414. In certain examples, the processes may be at least partially implemented in digital electronic circuitry, or in computer hardware, machine-readable instructions (including firmware and/or software), or in any combination thereof.

Although described specifically throughout the entirety of the instant disclosure, examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a plurality of data access object (DAO) interfaces to facilitate interactions with a plurality of heterogeneous data sources, wherein each of the plurality of DAO interfaces is to facilitate interaction with a different type of data source; and
a controller to receive an interaction request, to determine a data source of the plurality of data sources that is to service the interaction request, to select the DAO interface associated with the determined data source, and to implement the selected DAO interface to delegate communication of the interaction request for servicing of the interaction request by the determined data source.

2. The apparatus according to claim 1, wherein the controller is to access a configuration file that contains information that the controller is to use in determining the data source that is to service the interaction request.

3. The apparatus according to claim 2, wherein the information includes identifications of data stored in each of the plurality of heterogeneous data sources, and wherein the information is to be changed when at least one of the data stored in the plurality of heterogeneous data sources and the type of a data source change.

4. The apparatus according to claim 2, wherein the configuration information comprises data pertaining to at least one of locations of the plurality of heterogeneous data sources and identifications of the types of the plurality of heterogeneous data sources.

5. The apparatus according to claim 1, wherein the interface comprises a common user interface for access to each of the plurality of heterogeneous data sources.

6. The apparatus according to claim 1, wherein each of the plurality of DAO interfaces is to map the interaction request to a respective DAO associated with the determined data source and to forward the interaction request to the mapped DAO.

7. The apparatus according to claim 1, wherein the plurality of heterogeneous data sources comprise at least two of a lightweight directory access protocol (LDAP) database, a relational database, an extensible markup language (XML) database, and an enterprise active directory database.

8. A method for managing access to a plurality of heterogeneous data sources through utilization of a plurality of data access object (DAO) interfaces, and wherein each of the plurality of DAO interfaces is to facilitate interaction with a different type of data source, said method comprising:
receiving an interaction request;
determining a data source of the plurality of heterogeneous data sources that is to service the interaction request;
selecting a DAO interface of the plurality of DAO interfaces associated with the determined heterogeneous data source; and
implementing the selected DAD interface to delegate communication of the received interaction request for servicing of the interaction request by the determined data source.

9. The method according to claim 8, wherein receiving the interaction request further comprises receiving the interaction request through a common user interface for access to each of the plurality of heterogeneous data sources.

10. The method according to claim 8, wherein determining the data source further comprises accessing a configuration file that contains information identifying the data source that contains data associated with servicing of the interaction requests by the heterogeneous data sources.

11. The method according to claim 10, wherein the information includes identifications of data stored in each of the plurality of heterogeneous data sources, and wherein the information is to be changed when at least one of the data stored in the plurality of data sources and the type of a data source changes.

12. The method according to claim 8, wherein implementing the selected DAO interface further comprises implementing the selected DAO interface to map the interaction request to a respective DAO associated with the determined data source and to forward the interaction request to the mapped DAO.

13. A non-transitory computer readable storage medium on which is embedded a computer program, said computer program implementing a method of managing access to a plurality of heterogeneous data sources through utilization of a plurality of data access object (DAO) interfaces, and wherein each of the plurality of DAO interfaces is to facilitate interaction with a different type of data source, said computer program comprising computer readable code to:
receive an interaction request;
determine, through use of a configuration file, a data source of the plurality of heterogeneous data sources that is to service the interaction request, wherein the configuration file contains information pertaining to at least one of locations of the plurality of heterogeneous data sources and identifications of the types of the plurality of heterogeneous data sources;
select a DAO interface of the plurality of DAO interfaces associated with the determined heterogeneous data source; and
implement the selected DAO interface to delegate communication of the received interaction request for servicing of the interaction request by the determined data source.

14. The non-transitory computer readable storage medium of claim 13, wherein said computer program further comprises computer readable code to:
provide an interface to at least one user device through which the interaction request is to be received, wherein the interface is a common user interface for access to each of the plurality of heterogeneous data sources.

15. The non-transitory computer readable storage medium of claim 13, wherein said computer program further comprises computer readable code to:
implement the selected DAO interface to map the interaction request to a respective DAO associated with the determined data source and to forward the interaction request to the mapped DAO.
